(19) United States
(12) Patent Application Publication
(10) Pub. No.: US 2007/0273479 A1
(43) Pub. Date: Nov. 29, 2007

(54) Personalized device owner identifier

(75) Inventors: Edward K.Y. Jung, Bellevue, WA (US); Eric C. Leuthardt, St. Louis, MO (US); Royce A. Levien, Lexington, MA (US); Robert W. Lord, Seattle, WA (US); Mark A. Malamud, Seattle, WA (US); John D. Rinaldo, Bellevue, WA (US); Lowell L. Wood, Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/440,692

(22) Filed: May 25, 2006

(51) Int. Cl. G05B 19/00

(52) U.S. Cl. 340/5.81; 340/573.1; 340/572.1; 340/5.83; 382/124; 340/5.65

(57) ABSTRACT

One aspect of the disclosure relates to obtaining an identifiable aspect of a supposed owner of a personalized device; and determining whether the supposed owner of the personalized device is a true owner of the personalized device based at least in part on the obtaining an identifiable aspect of the supposed owner of the personalized device. Another aspect of the disclosure relates to obtaining a feature of a supposed owner; and identifying an aspect of a personalized device owner identifier based at least in part on the obtaining the feature of the supposed owner.

### TECHNICAL FIELD

Certain aspects of this disclosure can relate to, but are not limited to, a mechanism or technique that can identify an owner, possessor, or location of a personalized device owner identifier.

### BRIEF DESCRIPTION OF THE FIGURES

FIG. 1 is a block diagram of one embodiment of a personalized device owner identifier;

FIG. 2 is a diagram of one embodiment of the personalized device owner identifier;

FIG. 3 is a diagram of another embodiment of the personalized device owner identifier configured as a credit card;

FIG. 4 is a diagram of another embodiment of the personalized device owner identifier configured as a smart card;

FIG. 5 is a diagram of another embodiment of the personalized device owner identifier configured as an electronic key or radio frequency identity (RFID) device;

FIG. 6 is a diagram of another embodiment of the personalized device owner identifier configured as a license;

FIG. 7 is a diagram of another embodiment of the personalized device owner identifier;

FIG. 8 (including FIGS. 8a, 8b, and 8c) illustrates a flow chart of one embodiment of a personalized device owner identifier technique;

FIG. 9 is a diagram of another embodiment of the personalized device owner identifier; and

FIG. 10 (including FIGS. 10a and 10b) is a flow chart of another embodiment of a personalized device owner identifier technique.

### DETAILED DESCRIPTION

At least certain portions of the text of this disclosure (e.g., claims and/or detailed description and/or drawings as set forth herein) can support various different applications. Although, for sake of convenience and understanding, the detailed description includes section headings that generally track the general concepts as contained in one or more claims, and is not intended to limit the scope of the invention as set forth by each particular claim. It is to be understood that support for the various applications thereby can appear throughout the text and/or drawings, irrespective of the section headings.

### Certain Embodiments of a Personalized Device Owner Identifier

Certain embodiments of this disclosure can relate to a personalized device owner identifier 100 that can be associated with a personalized device 102. Within this disclosure, certain embodiments of the personalized device owner identifier 100 can include, but are not limited to, such personalized devices 102 as a credit card, a smart card, an electronic key, a radio frequency identity (RFID) device, a license, a debit card, and/or a personalized card.

With certain traditional personalized devices such as credit cards, smart cards, electronic keys, RFID devices, licenses, debit cards, personalized cards, etc., a considerable amount of trust in security of money, property, and/or identity is placed on the assumption that the possessor of the card is, indeed, the actual owner of the card. Certain embodiments of the personal device owner identifier 100 can provide a mechanism to enhance this assumption of trustworthiness.

One difficulty with certain traditional embodiments of personalized devices such as credit cards, smart cards, licenses, etc. is identity theft, property theft, or money theft. Within this disclosure, the term “owner” can mean, depending on context, an individual who can own, use, possess, or otherwise utilize certain embodiments of the personalized device, or alternately an individual who is issued or otherwise provided with certain embodiments of the personalized device for use by the individual.

Certain non-owner individuals can undesirably or illegally “pose” as owners by stealing their cards, numbers, or other information associated therewith. As such, one aspect of certain embodiments of the personal device owner identifier 100 is to determine whether a supposed owner (e.g., a person who holds themselves out to be a true owner) is indeed the owner or instead is an imposter. Owner/victims of such identity theft can often thereupon experience great difficulty in ever obtaining good credit. As a result of such identity theft, property theft, or money theft, companies, banks, etc. that provide traditional credit card, debit cards, etc. can often lose customer good will and customer trust. Identity theft, property theft, or money theft of such traditional embodiments of personalized devices as credit cards can occur as a result of third parties obtaining discarded credit card applications from unsolicited mailings to the intended owner, and the third parties using the information from such discarded or lost credit card applications to actuate the credit card. For example, certain non-owners can search garbage cans for discarded credit card applications that in many instances can be actuated over the phone by the non-owners, or others, posing as the owner. It is not uncommon for protracted legal fights to occur based on such identity theft, property theft, or money theft. Certain embodiments of the personalized device owner identifier 100, as described in this disclosure, can make it more difficult to electronically pose as other individuals in such a manner as to allow for the commission of identity theft, property theft, or money theft.

There are varied reasons for ensuring that individuals who hold themselves out to be owners of the personalized device are indeed the true owners. For example, operators of restaurants, stores, and other locations catering to those customers that are owners of such personalized devices as traditional credit cards, smart cards, debit cards, etc. may face a dilemma when offered a card from a person who may not be the true owner. Either the operator can thoroughly check out the identity of the person holding themselves out to be the owner (e.g., the supposed owner) which can take considerable time and possibly offend the owner if the person holding themselves out to be the owner is indeed the true owner, or the operator can lose the identity, money, goods, property, etc. associated with the theft if the supposed owner is not the true owner. With certain entry-based embodiments of the personalized device owner identifier such as an electronic key or RFID device, ensuring that the possessor is the true owner (and not, perhaps, someone who retrieved or stole someone else's key or RFID device) can improve security. For instance, it might be more difficult for a stranger to utilize a stolen or lost personalized device owner identifier to gain access into a dwelling, office, company location, hotel, motel, etc.

Certain embodiments of the personalized device 102 can have security aspects. It is not unusual to have counterfeits made (i.e., by an individual who is holding themself out to be the owner, but is not the true owner) of certain embodiments of such personalized devices as credit cards, smart cards, debit cards, licenses, electronic keys, RFID devices, etc. for a variety of reasons that can include but are not limited to theft of property, money, and/or identity. Certain embodiments of the traditional personalized devices such as credit cards, licenses, etc. can utilize relatively expensive devices to limit theft, misuse, misrepresentations, etc. For example, certain embodiments of the traditional personalized devices can utilize holograms that can be embedded in (e.g., the material forming) certain embodiments of traditional personalized devices. Certain embodiments of the embedded holograms can be difficult to accurately copy or reproduce, and are therefore associated with certain embodiments of credit cards, smart cards, debit cards, licenses, electronic keys, RFID devices, etc. which can be utilized to authenticate certain embodiments of the personalized device. Certain embodiments of personalized device owner identifier 100, as described in this disclosure, can make it difficult to effectively steal or counterfeit the associated personalized device.

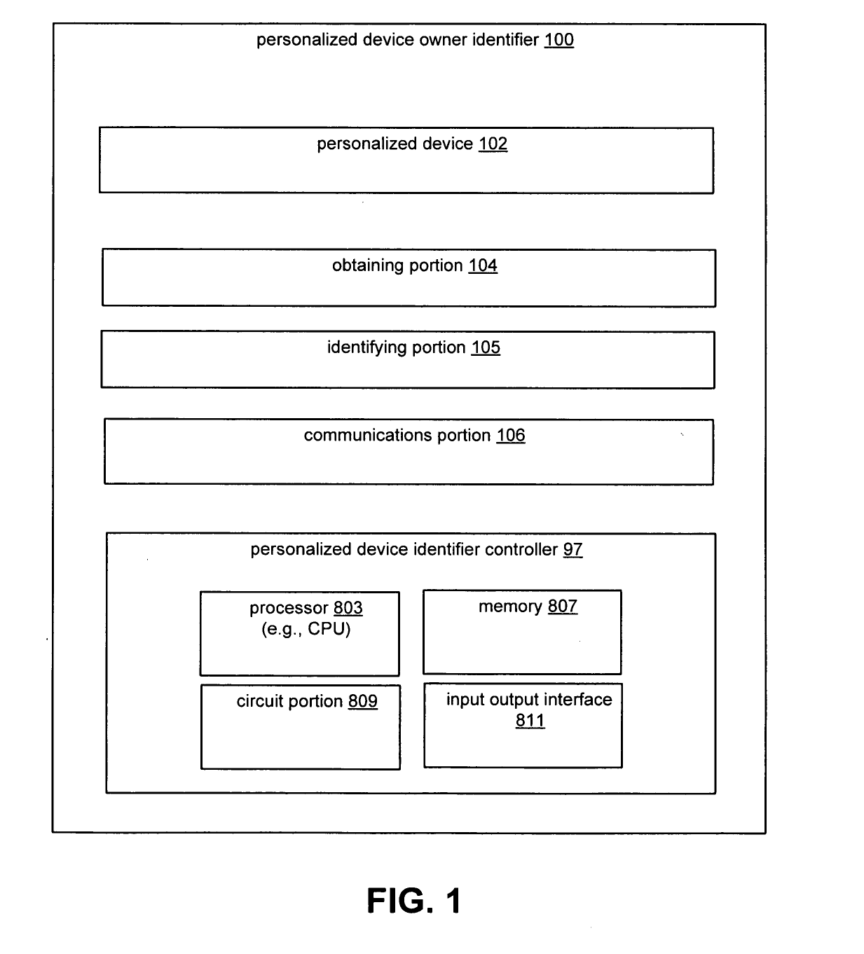

FIG. 1 shows a block diagram of certain embodiments of the personalized device owner identifier 100 that can include, but are not limited to, the personalized device 102, an obtaining portion 104, an identifying portion 105, a communications portion 106, and/or a personalized device identifier controller 97. Certain ones of these components may not be included in certain embodiments of the personalized device owner identifier 100. Certain embodiments of the personalized device 102 can include, but are not limited to, a credit card, a smart card, an electronic key, an RFID device, a license, a debit card, and/or a personalized identification card.

Certain embodiments of the personalized device owner identifier 100 may be configured as a stand-alone device, whose operation may not be related to another associated or networked computer device, phone, or controller device. Certain embodiments of the personalized device owner identifier 100 may become de-actuated to become ineffective upon theft or loss, for example, without the assistance of other computer devices, phone, or controller devices. Certain embodiments of the personalized device owner identifier 100 may be alternatively configured as a networked-device that can become de-actuated, and/or otherwise be made ineffective, upon theft or loss, for example, with the assistance of and/or interaction by another networked computing or controller device.

Within this disclosure, it is envisioned that certain embodiments of personalized device owner identifier 100 can be based at least in part and/or utilize phone, or other telecommunication technologies such as cell phones, land-based phones, etc. Certain embodiments of cell phones, for example, also provide positional information that can be used to position the cell phone. Certain embodiments of traditional cell phones include imaging devices that can be used to image the users, for example. Certain embodiments of cell phones, for example, also contain processors, communication devices, and/or control devices that can be utilized in certain embodiments of the positional device owner identifier, as described in this disclosure. As such, it is envisioned that much of the telecommunication technology may in the future integrate such personalized devices as credit cards, smart cards, etc. This could thereby also be used to reduce the number of such personalized devices as cards, licenses, etc. that have to be carried upon the person.

While it is unlikely that certain embodiments of the personalized device owner identifier 100 can identify individuals with a one-hundred percent accuracy, an improvement in the probability of accurate identification of the correct owner and/or any improvement in identification in an incorrect, e.g., non-owner, possessor of certain embodiments of the personalized device owner identifier 100 can act as a considerable deterrent to theft and/or possible misuse of the personalized device 102, as well as greater acceptance of certain embodiments of the personalized device.

Adoption of certain embodiments of the personalized device owner identifier 100 by credit card companies, banks, etc. could be interpreted by certain personalized device owners as a very positive step against identity theft, property theft, or money theft. It appears likely that such personalized device companies as credit card companies, license issuers, banks, and the like would embrace use of such technology that could in certain embodiments, and with proper utilization, considerably reduce commercial theft, property theft, as well as identity theft. Owners, users, or other consumers of the personalized device 102 would likely appreciate the additional security provided against theft, etc. Additionally, those companies issuing certain embodiments of personalized devices 102 in the future that do not include certain embodiments of the personalized device owner identifier 100 (that could in certain embodiments and with proper utilization reduce theft of money, property, and/or identity) may be considered as providing a sub-par product that would likely not meet the security considerations and security demands of their customers, the true owners.

Certain embodiments of the personalized device owner identifier 100 can be configured as a stand-alone device which could operate by itself, and quickly identify a correct owner or incorrect owner largely by itself. Other embodiments of the personalized device owner identifier can be configured as a networked device that transmits information to other devices, which can, in turn, provide at least some of the operability of the personalized device owner identifier. Such different configurations of the personalized device owner identifier 100 that operate differently may be configured differently. For instance, certain embodiments of the personalized device owner identifier 100 that are configured as standalone devices might be expected to include owner identifier information or data pertaining to the appearance of the owner.

By comparison, certain embodiments of the personalized device owner identifier 100 that may be configured as networked devices may not include the owner identifier information or data therein, but instead they can communicate with a remote device that includes the owner identifier information or data. Therefore, more than one device can act as one or more of the portions of the personalized device owner identifier 100 as described with respect to FIG. 1. As such, this disclosure describes a number of embodiments of the personalized device owner identifier 100, and additionally describes certain variations therein based on the use or operation of certain particular embodiments of the personalized device owner identifier.

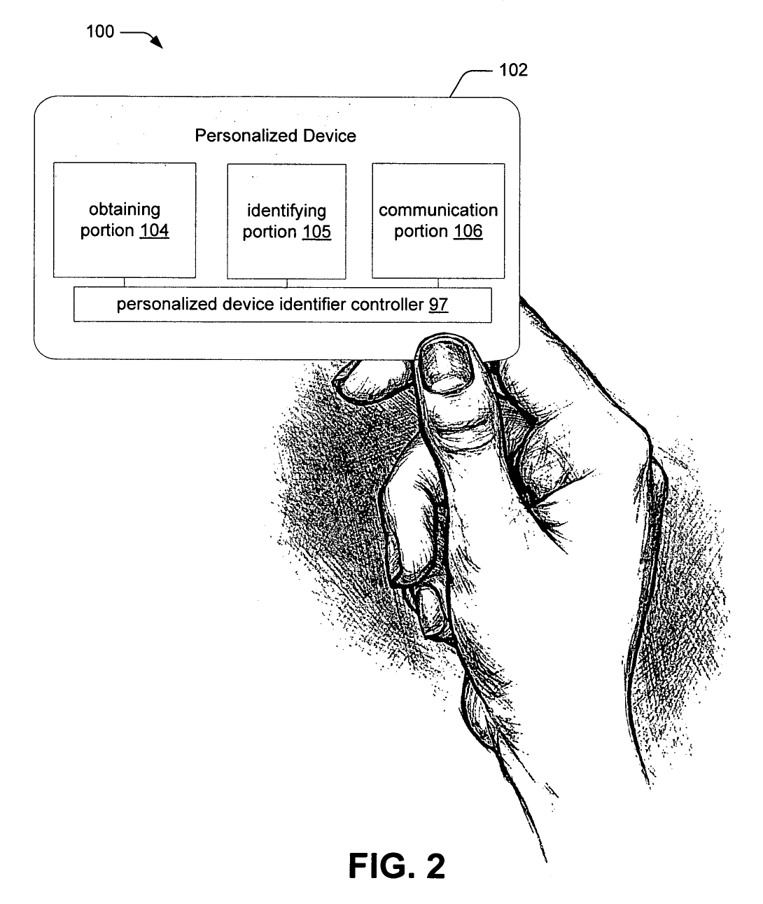

Size and weight are often a consideration with certain embodiments of conventional personalized device such as a credit card, smart card, debit card, license, etc., which are configured to fit within a wallet, a purse, a pocket, etc. Such size and weight limitations are also the case with certain embodiments of the personalized device owner identifier 100. In general, people do not wish to carry around too many bulky items in a regular basis on their person, in a wallet or purse, in their pockets, etc. As such, certain embodiments of the personalized device 102 would preferably be configured to fit within a wallet, a purse, a pocket, etc. as described with respect to FIG. 2. Recent technology has provided for the creation of a number of embodiments of a “credit card-sized camera”, which are commercially available, have similar outside dimensions (height and width) of a traditional credit card, and in certain embodiments less than a quarter (or even considerably less than an eighth) of an inch in thickness. Certain embodiments of the credit card-sized cameras can capture digital images. One aspect of certain embodiments of the personalized device owner identifier 100 is that the quality of certain embodiments of the obtaining portion 104 need not be very good. For example, certain embodiments of the obtaining portion 104 are being used to identify the individual as compared to providing a permanent image, record, photograph, etc. Therefore, since dimensions are important with certain embodiments of the personalized device owner identifier, an image, recording, etc. that can be satisfactorily used for identification purposes may be satisfactory.

Within this disclosure, certain commercially available embodiments of the credit-card sized camera (which are designed primarily to obtain images) should not be confused with certain embodiments of the personalized device owner identifier 100 that can identify an owner of the personalized device 102 using imaging or other techniques.

Certain embodiments of the personalized device owner identifier 100 can utilize similar technology to, as described in this disclosure, utilize similar imaging technology, processing technology, communication technology, wireless communications technology, etc. as already provided in certain embodiments of traditional credit card cameras to identify a possessor of the personalized device 102, the location of the personalized device, or other such information.

Certain embodiments of a credit/identity issuing authorities can include one or more controlling entities such as credit-card companies, debit card companies, banks, department of motor vehicles, licensing authorities, etc. Certain embodiments of the personalized device owner identifier 100 may be configured as joint-issued devices, such in which the owner may be able to interface with accounts in one or more credit/identity issuing authorities using a single one of certain embodiments of the personalized device owner identifier 100. As such, instead of each owner carrying around a considerable number of personalized devices 102 on their person, certain embodiments of the personalized device owner identifier 100 can be authorized or configured to multiple credit-identity or identity issuing authorities which can each “share” certain embodiments of the personalized device owner identifier 100, provided that the security aspect for each issuing authority can be segmented and/or maintained robustly. Certain issuers of the personalized device owner identifier 100 (e.g., a motor vehicle department or certain credit cards) may require their customers to have a devoted personalized device owner identifier 100, but as the convenience and security of certain embodiments of the personalized device owner identifier 100 become more pronounced, those issuing authorities requiring devoted embodiments should diminish.

Certain traditional embodiments of smart cards, credit cards, debit cards, electronic keys, RFID devices, etc. can utilize the modifiable data/information memory locations or encoders that store identification data or information. It is important for certain joint-issued embodiments of the personalized device owner identifier 100 to be configured to reproduce such identification data or information. As such, certain embodiments of the personalized device owner identifier 100 can include the modifiable data/information memory locations that can be altered depending upon the particular use of the personalized device owner identifier 100. For example, certain embodiments of the personalized device owner identifier 100 can be used as an electronic key or RFID device when appropriately configured, and then be reconfigured as a credit card, smart card, a debit card, or another personalized device 102.

Certain embodiments of the personalized device 102 can be initiated upon issuance, to the particular owner or said owners. For example, certain embodiments of an RFID card, a smart card, the debit card, a credit card, electronic key, or other personalized device 102 can be initiated to or by a person upon issuance. Certain embodiments of an electronic key can be issued to a member of family or group, for example, staying at a hotel or the dwelling. A variety of information in certain embodiments of the personalized device can be modified, such as different people are provided access or use an electronic key. A subsequent process such as re-initializing can be utilized to reassign certain embodiments of the personalized device. Such processes as initializing and re-initializing are understood across a variety of technologies such as computers, phones, controllers, microprocessors, etc., which may be utilized in different embodiments of personalized devices and will not be further detailed or described herein.

Reconfiguration of the modifiable data/information memory locations can be automatic with certain embodiments of the personalized device owner identifier 100, such as by interaction with or positioning nearby of certain devices (e.g., an electronic lock, a credit card reader, a debit card reader, or a smart card reader, etc.). Reconfiguration of the modifiable data/information memory locations can be manual with certain embodiments of the personalized device owner identifier 100, such as by a user interfacing with some selection device or user interface included in certain embodiments of the personalized device owner identifier 100. For example, an owner of certain embodiments of the personalized device owner identifier 100 can select that the personalized device (e.g., the modifiable data/information memory locations) can be configured as one particular personalized device (e.g., electronic key or RFID device,) at one time, and then another personalized device (e.g., smart card, credit card, or debit card) at another time.

At still another time, certain embodiments of the modifiable data/information memory locations of the personalized device owner identifier 100 can be configured as still another personalized device. Such reconfiguration of certain embodiments of the personalized device 102 can be performed, for example, by a user interface that can configure the personalized device in a desired configuration at a particular period. For example, an owner of the personalized device may be queried as to which personalized device they desire (e.g., select one for a license, select two for a credit card, select three for a debit card, etc.). As such, certain embodiments of the personalized device owner identifier 100 can be configured to perform or act as one or more different personalized devices 102 at different times. The owner of a personalized device can thereby carry around fewer personalized devices in their pocket, wallet, or purse, for example, since each personalized device owner identifier or personalized device can be configured to act as one, two, or more personalized device(s) 102.

Certain embodiments of the obtaining portion 104 can include a camera, an imager, a still-picture device, a motion picture device, a fingerprint detector, a facial characteristic imager (e.g., to consider color, texture, facial hair, etc.), or another such device that can be used to improve the identifying an owner of the personalized device 102, identify a rightful possessor of the personalized device, identify theft of the personalized device, and/or identify location of the personalized device, or other types of activities associated with the personalized device, etc. As such, certain embodiments of the obtaining portion 104 can capture or image raw data that can be used to identify an owner of the card, and whether the current possessor is the owner.

Certain information as a location of the personalized device 102 can be used to deduce whether, or improve evidence indicating, that a possessor of the personalized device either is, or is not, the true owner. For example, if the owner of the personalized device lives, or does business in, a particular location such as California, and that information or additional information indicates the owner is currently at home; information from the personalized device 102 indicating that it might be in a distant state or country and is being attempted to be used should, at the least, raise a flag or concern among both the legitimate owner and the company or entity providing the personalized device. As such, certain embodiments of the personalized device owner identifier 100 can be programmed utilizing suitable or obvious logic, etc.

Relatively recent advances in technology have made the application of obtaining portions 104 such as cameras or other imagers to a number of embodiments of the personalized devices 102, such as credit cards, possible. For example, a number of companies offer credit card-sized cameras that have a similar height and width to credit cards, and is relatively thin (a quarter of an inch or less, even to a sixteenth of an inch). A miniaturized sized imaging device can be associated with the obtaining portion 104. The particular facial, fingerprint, audio, or other features that may be used to identify each particular rightful owner of certain embodiments of the personalized device owner identifier 100 may differ, and in certain embodiments may even be unknown to certain owners and/or possessors.

One advantage of certain embodiments of the personalized device owner identifier 100 is that as a part of the authorization, a person holding themselves out to be the owner of the personalized device can be asked to interface with the personalized device owner identifier 100 to indicate they are, indeed, the true owner. Such interface can take such diverse forms as, but not limited to: capturing an image, or other identifying information, that can be compared to that of the true owner, owners using an image recognition or other suitable program from a sample situated either under control of the credit/identity issuing authority or within the personalized device 102; imaging or otherwise obtaining fingerprints that can be compared with a sample obtained from the owner that sees their within the personalized device 102 or under the control of the credit/identity issuing authority, a voice-print that can be recorded and similarly compared with a sample can be provided by the owner that is either within the personalized device 102 or under the control of the credit/identity issuing authority, or similarly compared personally identifiable image or information, etc. After commercial acceptance of certain embodiments of the personalized device owner identifier 100, a considerable amount of expense associated with credit card theft, debit card theft, identity theft, etc. will likely be reduced from both the credit/identity issuing authorities and the card owners; and those attempting to steal and/or use credit cards, debit cards, identities, etc. will find it more difficult. In addition, those attempting to improperly or illegally use certain embodiments of the personalized device owner identifier 100 will likely experience a greater probability of being caught. Consider that a considerable expense associated with traditional credit/identity issuing authorities such as credit card/debit card companies involves the theft thereof. Consumers or users of certain embodiments of the personalized device 102 are often forced to pay increased or exorbitant fees largely to overcome the risk associated with identity theft, property theft, money theft, identity fraud, and/or other misuse of certain traditional personal devices.

Certain embodiments of the personalized device owner identifier 100 can include, but are not limited to, personal identification information or data that can be used to identify the owner. Certain embodiments of the personal identification information can include an image of the owner, photographic information (e.g., if the owner is male or female, their name, their skin color, etc.) of the owner, or other such information that can be used to identify the owner as compared to an impostor.

During operation of certain embodiments of the personalized device owner identifier 100 as described with respect to FIG. 1, the obtaining portion 104 as can be associated with the personalized device owner identifier 100 can obtain an image, a voiceprint, a retinal scan, etc. of the supposed owner of the personalized device 102. Thereupon, certain embodiments of the identifying portion 105 can, in indifferent embodiments, be physically or operationally within the personalized device, or alternatively another device associated with the personalized device such as a reader or networked device, or in some combination thereof. Certain embodiments of the personalized device owner identifier 100 can provide some operational identification such as, but not limited to, comparing the image, voice print, retinal scan, etc. that were obtained by the obtaining portion 104 with corresponding identify information contained are stored in within the personalized device owner identifier 100 (or some associated or networked device). Certain embodiments of the identifying portion 105 can thereby operate utilizing a variety of embodiments of image recognition, voice recognition, or other recognition programs to ensure that the individual holding themselves out to be the owner is indeed the true owner of the personalized device.

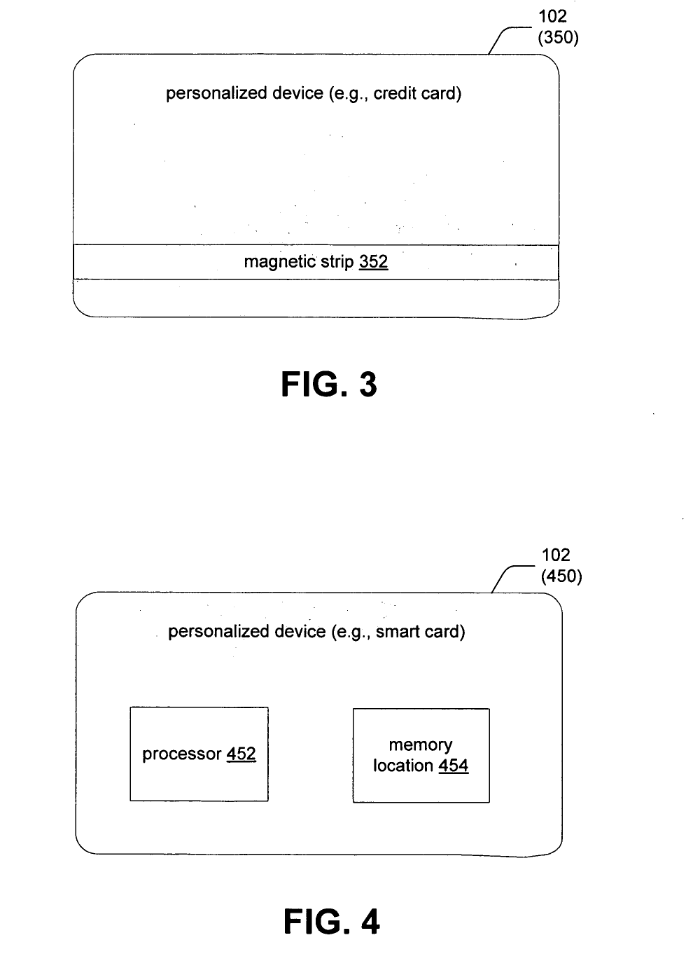

A number of embodiments of the personalized device 102 that can be included as the personalized device owner identifier 100 are described with respect to FIGS. 3-6.

Certain embodiments of the personalized device owner identifier 100 as described with respect to FIG. 3 that includes a credit card 350 as the personalized device 102. Certain embodiments of the credit card 350 (which, a disclosure, can include a debit card) can include magnetic strip 352 which can be configured to record information, such as data pertaining to the owner, the credit card number, in a non-volatile fashion. Certain embodiments of the data information stored on the magnetic strip 352 of the credit card 350 can be when, for example, by credit card readers (not shown). Such credit card readers are commercially available and generally known as technology, and will not be described or detailed herein as described with certain embodiments of the personalized device owner identifier 100. Certain embodiments of the magnetic strip 352, such as used in credit cards, have demonstrated themselves to be a relatively economic mechanism to maintain credit card information, or other such information that should not be altered. A considerable percentage of the credit cards, debit cards, etc. as utilized within the United States relies largely upon the magnetic strip technology.

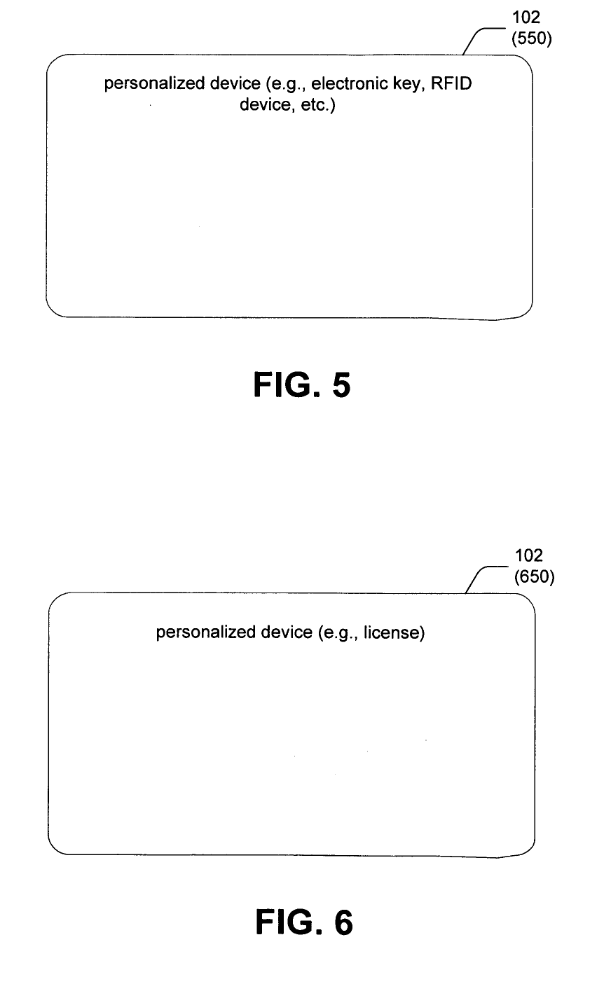

Certain embodiments of the personalized device owner identifier 100 as described with respect to FIG. 4 that can include a smart card 450 as the personalized device 102. Certain embodiments of the smart card 450 are configured to interface with certain embodiments of commercially available smart card readers, such as generally known by those skilled in the relevant technologies. Traditional embodiments of smart card are in common usage (particularly in Europe) for such applications as phone cards, bank cards, identity cards, etc., and are gaining greater acceptance in the U.S. Certain embodiments of the smart card 450 can be configured with electronic contacts, by which a suitable electric charge can be applied thereto (e.g., to allow some operation to be performed by the smart card), such as when interfacing with a suitable smart card reader, suitable operation can be performed using the smart card. By comparison, Certain embodiments of the smart card 450 can include, but are not limited to, a processor 452 such as a microprocessor and a memory location 454. Data and/or information contained in certain embodiments of the smart card 450 therefore can be modified such as to change a state, status, amount, value, condition, or other aspect relating to the personalized device. Other embodiments of processor 452 can also be used such as a microcomputer, processor, computer, phones, controller, etc. as described in this disclosure.

Certain embodiments of the personalized device owner identifier 100 can either by themselves, or with interaction with another device, obtain an image, a voiceprint, a retinal scan, etc. of the supposed owner of the personalized device 102. Thereupon, certain embodiments of the identifying portion 105 can compare the image, voice print, retinal scan, etc. that were obtained by the obtaining portion 104 with corresponding identifying information that can be contained within the memory location 454 of the personalized device owner identifier 100.

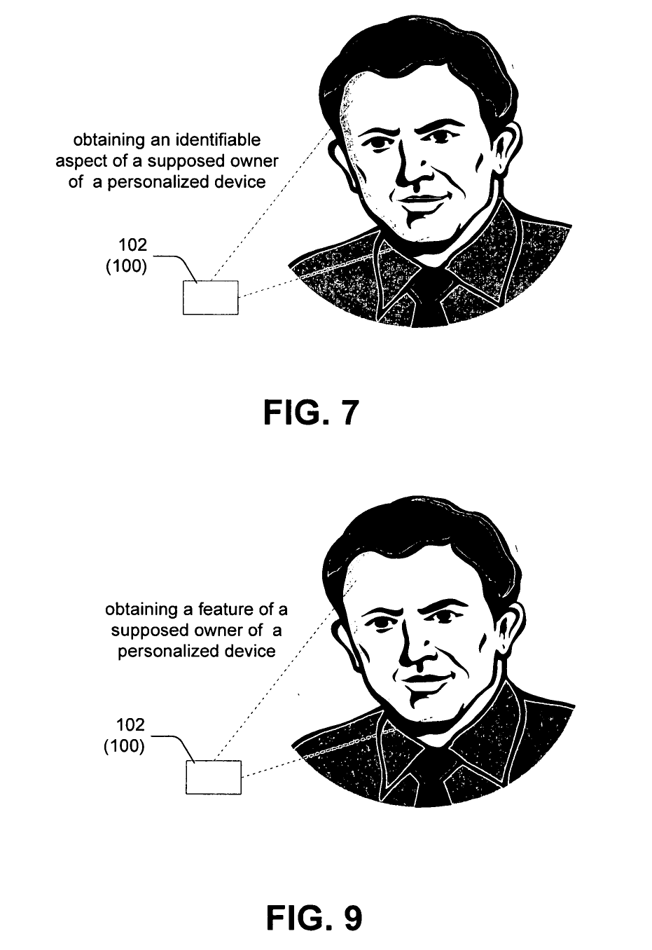

Certain embodiments of the personalized device owner identifier 100 as described with respect to FIG. 5 that can include an electronic key 550 or RFID device as the personalized device 102. Certain embodiments of the electronic key 550 or RFID device can be configured to provide access to individuals into such places as homes, dwellings, businesses, hotels, etc. Certain embodiments of the electronic key 550 or RFID device can be configured to interface with certain embodiments of a commercially-available electronic lock, such as generally understood by those skilled in the art such that when a possessor who identifies themselves to be the owner, but is not true owner, the electronic key or RFID device will not open the electronic lock. By comparison, when the electronic key or RFID device is possessed by the true owner, the electronic key or RFID device will open the electronic lock.

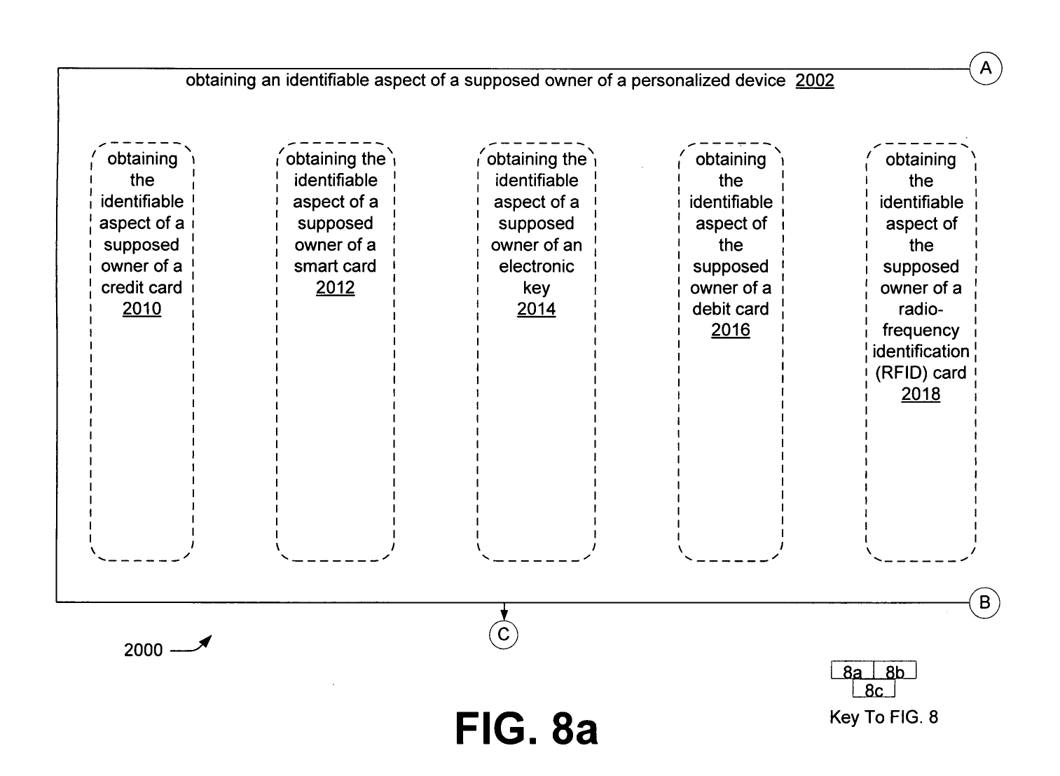

Certain embodiments of the personalized device owner identifier 100 as described with respect to FIG. 6 that can include a license 650 as the personalized device 102. The configurations of licenses can vary considerably from country to country, from state to state, from locale to locale, etc. As such, certain embodiments of licenses can contain data in magnetic strips, microcomputer storage, cell-phone storage, or other mechanisms similar to as described in the other embodiments of the personalized devices of FIGS. 1 to 5.

This disclosure describes the interaction between the different embodiments of the personalized device owner identifier 100 such as described with respect to FIGS. 2 to 6, and the device(s) which they interact with, the readers associated therewith, etc. Certain embodiments of the personalized device owner identifier 100 can be actuated in those instances when the identifying portion 105 does not indicate that the person holding themselves out to be the owner is not the true owner of the personalized device 102. Such deactuation mechanisms can vary between the different embodiments of the personalized device owner identifier 100 and their associated technologies. For instance, with certain credit card-based embodiments of the personalized device owner identifier as described with respect to FIG. 3, the deactuation mechanism can involve the magnetic strip 352 being shielded, erased, covered, or other technique to limit reading by the credit card reader. By comparison, certain embodiments of smart card-based embodiments of the personalized device owner identifier as described with respect to FIG. 4, the deactuation mechanisms can involve the processor not allowing information retrieval, or processing, relative to the smart card. As such, the different embodiments of the deactuation mechanism can cause the smart card to “go to sleep” operationally, and thereby not act as a smart card as possessed by the true owner. Certain embodiments of deactuation or modification of the personalized device 102 can even involve destroying or destructing the personalized device owner identifier 100.

### Certain Embodiments of the Personalized Device Identifier Controller

This disclosure describes a number of embodiments of the personalized device identifier controller 97 as described with respect to FIG. 1 that are intended to control operations of the personalized device owner identifier 100. Certain embodiments of the personalized device identifier controller can act as and can provide the functionality of the at least a portion of the feedback mechanism to either certain embodiments of the personalized device owner identifier 100 as described with respect to FIG. 1. Certain embodiments of the personalized device identifier controller 97 can be configured as a standalone device, while other embodiments of the personalized device identifier controller can be configured as a networked device.

FIG. 1 shows a block diagram of certain respective embodiments of the personalized device owner identifier 100 that can include the personalized device identifier controller 97. Certain embodiments of the personalized device owner identifier 100 thereby can include, but are not limited to, any particular configuration of the personalized device identifier controller 97. Certain embodiments of the personalized device identifier controller 97 can be computer based, controller based, mote based, phone based, and/or electronics based. Certain embodiments of the personalized device identifier controller can be segmented into modules, and can utilize a variety of wireless or wired-based communication and/or networking technology to allow information, data, etc. to be transferred to the various distinct portions or embodiments of the personalized device owner identifier 100. Certain embodiments of the personalized device identifier controller 97 can be configured as a unitary or stand alone device.

Certain embodiments of the personalized device identifier controller 97 can vary as to their automation, complexity, and/or sophistication. As described within this disclosure, multiple ones of the different embodiments of the personalized device owner identifier 100 can transfer information about the personalized device, system, device, machine, etc., or their condition, information or data relating to the fluid(s) and/or element(s), signals, etc. via a communication link to or from a personalized device and/or some intermediate device as might be associated with monitoring and/or other activities.

Certain embodiments of the personalized device identifier controller 97, as well as certain embodiments of the personalized device owner identifier 100, in general, can utilize distinct firmware, hardware, and/or software technology. For example, mote-based technology, phone-based technology, microprocessor-based technology, microcomputer-based technology, general-purpose computer technology, specific-purpose to computer technology, and a variety of other computer technologies can be utilized for certain embodiments of the personalized device identifier controller 97, as well as certain embodiments of the personalized device owner identifier 100.

Certain embodiments of the personalized device identifier controller 97 can as described with respect to FIG. 1 can include a processor 803 such as a central processing unit (CPU), a memory 807, a circuit or circuit portion 809, and an input output interface (I/O) 811 that may include a bus (not shown). Certain embodiments of the personalized device identifier controller 97 of the personalized device owner identifier 100 can include and/or be a portion of a general-purpose computer, a specific-purpose computer, a microprocessor, a microcontroller, a phone, a personal display assistant (PDA), a cellular phone, a wireless communication device, a hard-wired phone, and/or any other known suitable type of communications device, computer, and/or controller that can be implemented in hardware, software, electromechanical devices, and/or firmware. Certain embodiments of the processor 803, as described with respect to FIG. 1, can perform the processing and arithmetic operations for certain embodiments of the personalized device identifier controller 97 of the personalized device owner identifier 100. Certain embodiments of the personalized device identifier controller 97 of the personalized device owner identifier 100 can control the signal processing, database querying and response, computational, timing, data transfer, and other processes associated with certain embodiments of the personalized device identifier controller 97 of the personalized device owner identifier 100.

Certain embodiments of the memory 807 of the personalized device identifier controller 97 can include a random access memory (RAM) and/or read only memory (ROM) that together can store the computer programs, operands, and other parameters that control the operation of certain embodiments of the personalized device identifier controller 97 of the personalized device owner identifier 100. The memory 807 can be configurable to contain the information or individual information obtained, retained, or captured by that particular personalized device identifier controller 97 of the personalized device owner identifier 100. Certain embodiments of the memory 807 can at least partially include the modifiable data/information memory locations, as described in this disclosure.

Certain embodiments of the bus can be configurable to provide for digital information transmissions between the processor 803, circuits 809, memory 807, I/O 811, and/or the image memory or storage device (which may be integrated or removable). In this disclosure, the memory 807 can be configurable as RAM, flash memory, semiconductor-based memory, of any other type of memory that can be configurable to store data pertaining to images. The bus also connects I/O 811 to the portions of certain embodiments of the personalized device identifier controller 97 of either the personalized device owner identifier 100 that either receive digital information from, or transmit digital information to other portions of the personalized device owner identifier 100 or other systems are networking components associated with.

Certain embodiments of the personalized device identifier controller 97 of the personalized device owner identifier 100, as described with respect to FIG. 1, can include a transmitter portion (not shown) that can be either included as a portion of certain embodiments of the personalized device identifier controller 97 of the personalized device owner identifier 100. Certain embodiments of the personalized device identifier controller 97 can alternately be provided as a separate unit (e.g., microprocessor-based). In certain embodiments, the transmitter portion can transmit image information between certain embodiments of the personalized device identifier controller 97 of the personalized device owner identifier 100.

Certain embodiments of the personalized device identifier controller 97 of the personalized device owner identifier 100 as described with respect to FIG. 1 can include an operation altering portion (not shown) that can be either included as a portion of certain embodiments of the personalized device identifier controller 97 of the personalized device owner identifier 100 can be provided as a separate unit (e.g., microprocessor-based). Examples of operation altering portions include, but are not limited to, altering a resolution, altering a contextual library, altering an initial condition, altering an aspect ratio, altering a color intensity and/or brightness or particular parameter or characteristic of the personalized device owner identifier 100.

Certain embodiments of the memory 807 can provide one example of a memory storage portion. In certain embodiments, the monitored value includes but is not limited to: a percentage of the memory 807, a number of images that are stored in the memory 807, or for data storage or recording interval (audio or video recording intervals).

To provide for overflow ability for the memory 807 of certain embodiments of the personalized device identifier controller 97 of the personalized device owner identifier 100, the image storage device can be operably coupled to the memory 807 to allow a controllable transmitting of memory data from certain embodiments of the personalized device identifier controller 97 of the personalized device owner identifier 100 when the monitored value of data within the memory 807 (e.g., the memory storage portion) exceeds a prescribed value. The prescribed value can include, e.g., some percentage amount or some actual amount of the value.

In certain embodiments, a secondary communication link can be established between the certain embodiments of the personalized device identifier controller 97 of the personalized device owner identifier 100. The secondary communication link can be structured similar to as a communication link, or alternatively can utilize network-based computer connections, phone connections, Internet connections, etc. to provide information and/or data transfer between certain embodiments of the personalized device identifier controller 97 of the personalized device owner identifier 100.

In certain embodiments of the personalized device identifier controller 97 of the personalized device owner identifier 100, the particular elements of certain embodiments of the personalized device identifier controller 97 of the personalized device owner identifier 100 (e.g., the processor 803, the memory 807, the circuits 809, and/or the I/O 811) can provide a monitoring function to convert raw data as displayed by an indicator. A monitoring function as provided by certain embodiments of the personalized device identifier controller 97 of the personalized device owner identifier 100 can be compared to a prescribed limit, such as whether the number of images contained in the memory 807, the amount of data contained within the memory 807, or some other measure relating to the memory is approaching some value. The limits to the value can, in different embodiments, be controlled by the user or the manufacturer of certain embodiments of the personalized device identifier controller 97 of the personalized device owner identifier 100. In certain embodiments, the memory 807 can store such information as data, information, displayable information, readable text, motion images, video images, and/or audio images, etc.

In certain embodiments, the I/O 811 provides an interface to control the transmissions of digital information between each of the components in certain embodiments of the personalized device identifier controller 97 of the personalized device owner identifier 100. The I/O 811 also provides an interface between the components of certain embodiments of the personalized device identifier controller 97 of the personalized device owner identifier 100. The circuits 809 can include such other user interface devices as a display and/or a keyboard. In other embodiments, the personalized device identifier controller 97 of the personalized device owner identifier 100 can be constructed as a specific-purpose computer such as an application-specific integrated circuit (ASIC), a microprocessor, a microcomputer, or other similar devices. A variety of vehicles, factories, machines, medical devices, devices, locations, etc. could be configured as and/or include certain embodiments of the personalized device owner identifier 100. A variety of vehicles, seats, etc. can also be configured with certain embodiments of the personalized device owner identifier 100.

### Certain Embodiments of Personalized Device Owner Identifier with Relevant Flowcharts

Within the disclosure, flow charts of the type described in this disclosure apply to method steps as performed by a computer or controller. The flow charts can also apply to apparatus devices, such as an antenna or a node associated therewith that can include, e.g., a general-purpose computer or specialized-purpose computer whose structure along with the software, firmware, electro-mechanical devices, and/or hardware, can perform the process or technique described in the flow chart.

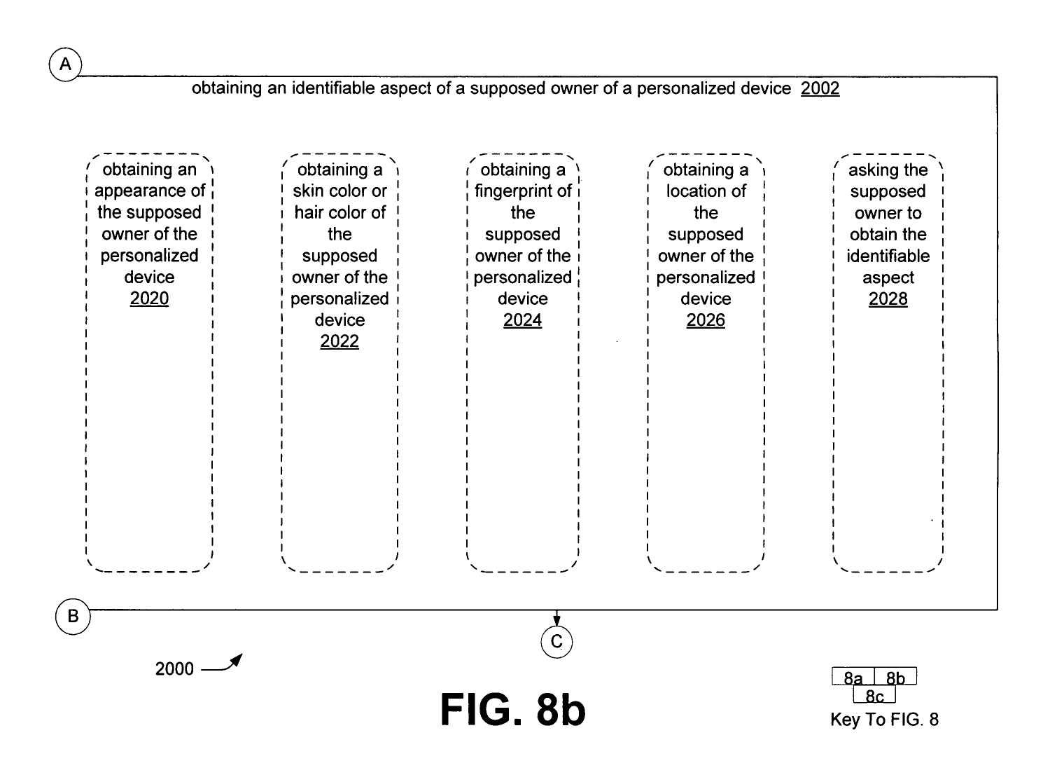

FIG. 7 shows one embodiment of the personalized device owner identifier 100, which can be configured to identify the owner of the personalized device 102 based, at least in part, on identifying the owner of the personalized device. Examples of identifying techniques can include, but are not limited to, capturing images of identifiable aspects of the owner, retinal scans of the owner, voice prints of the owner, etc. as described in this disclosure. Certain embodiments of an identifying mechanism can thereupon be utilized to determine whether the supposed owner of the personalized device is a true owner of the personalized device based at least in part on the obtaining the identifiable aspect of the supposed owner of the personalized device.

Different embodiments of the obtaining the identifiable aspect can be performed at the personalized device under the control of the owner, or under the control of another device. For example, certain embodiments of the personalized device can be actuated at prescribed times such as when a purchase is made using the personalized device, or an entry is made into a building or dwelling using the personalized device. Consider each time an owner makes a purchase using a credit card, a debit card, or a smart card, the user can confirm their identity using the particular personalized device as described herein. Such identification can be useful to ensure that the personalized device is not stolen, etc. Such confirmation of the identity of the owner should further assure those doing business with the owner.

Certain embodiments of the personalized device owner identifier can identify the supposed owner or possessor of the card as the true owner utilizing a remote and/or automated mechanism. For example, the personalized device owner identifier can be actuated periodically to ensure that it has not been stolen. Certain embodiments of the personalized device owner identifier can also utilize positional information (such as GPS-derived information) to detect where the user or personalized card is situated. If such personalized device is stolen, then the positional information can be utilized to track the location of the personalized device, and perhaps the theft of the personalized device. In certain embodiments, the positional information can be transmitted between the personalized device and other computer, controller, or communication devices using networking or other communication techniques and/or systems.

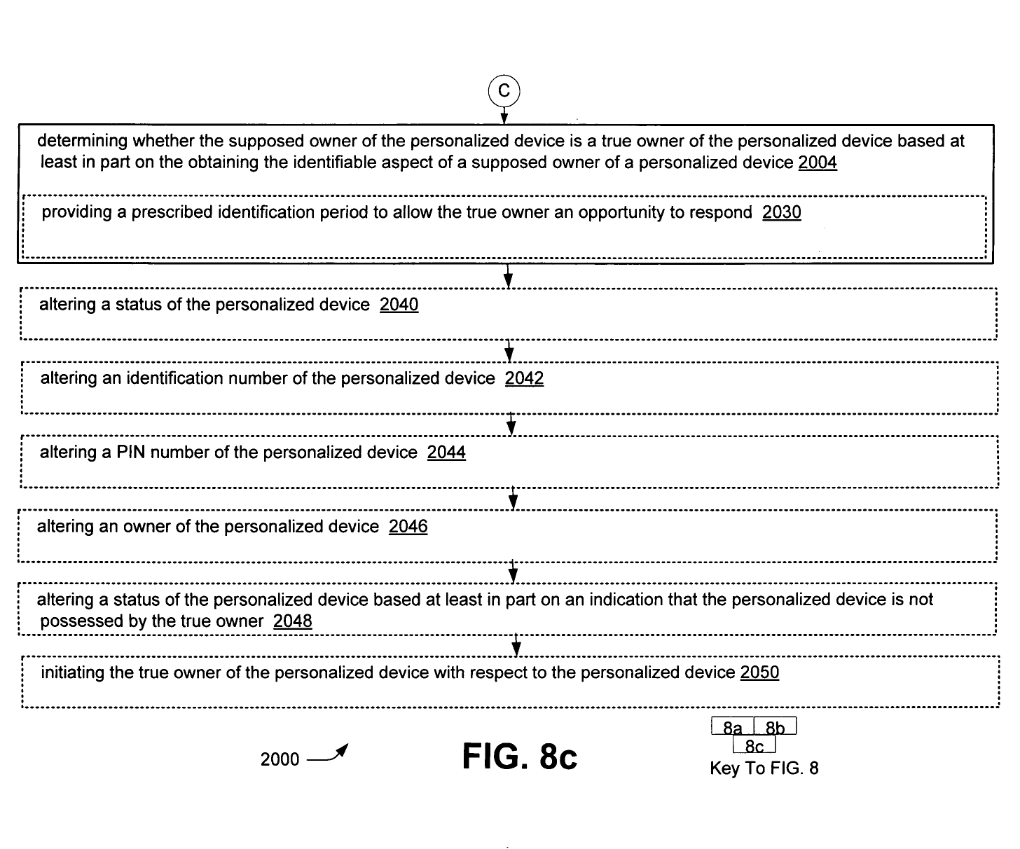

One embodiment of a high-level flowchart of a personalized device owner identifier technique 2000 is described with respect to FIG. 8 (including FIGS. 8a to 8c) and can include, but is not limited to, operations 2002 and 2004, and optional operations 2040, 2042, 2044, 2046, 2048, and/or 2050. One embodiment of operation 2002 can include, but is not limited to, optional operations 2010, 2012, 2014, 2016, 2018, 2020, 2022, 2024, 2026, and/or 2028. One embodiment of operations 2004 can include, but is not limited to, optional operation 2030. The high-level flowchart of FIG. 8 (including FIGS. 8a to 8c) should be considered in combination with the embodiments of the personalized device owner identifier 100, as described with respect to FIG. 7. One embodiment of operation 2002 can include, but is not limited to, obtaining an identifiable aspect of a supposed owner of a personalized device. For example, obtaining an identifiable image (of the face, fingerprints, another identifiable aspect of the owner, etc.), taking an identifiable voice print, obtaining an identifiable retinal scan, etc. of the supposed owner of the personalized device. One embodiment of operation 2004 can include, but is not limited to, determining whether the supposed owner of the personalized device is a true owner of the personalized device based at least in part on the obtaining the identifiable aspect of the supposed owner of the personalized device. For example, utilizing the identifiable image to determine whether the supposed owner is the true owner. One embodiment of the obtaining an identifiable aspect of a supposed owner of a personalized device of operation 2002 can include operation 2010, that can include, but is not limited to, obtaining the identifiable aspect of the supposed owner of a credit card. For example, wherein the personalized device includes the credit card, as described in this disclosure. One embodiment of the obtaining an identifiable aspect of a supposed owner of a personalized device of operation 2002 can include operation 2012, that can include, but is not limited to, obtaining the identifiable aspect of the supposed owner of a smart card. For example, wherein the personalized device includes the smart card, as described in this disclosure. For example, the obtaining the identifiable aspect can include, but is not limited to, capturing an identifiable image, taking a retinal scan, capturing a voice print, etc. One embodiment of the obtaining an identifiable aspect of a supposed owner of a personalized device of operation 2002 can include operation 2014, that can include, but is not limited to, obtaining the identifiable aspect of the supposed owner of an electronic key. For example, where the personalized device includes the electronic key, or other RFID device, as described in this disclosure. One embodiment of the obtaining an identifiable aspect of a supposed owner of a personalized device of operation 2002 can include operation 2016, that can include, but is not limited to, obtaining the identifiable aspect of the supposed owner of a debit card. For example, wherein the personalized device includes the debit card, as described in this disclosure. One embodiment of the obtaining an identifiable aspect of a supposed owner of a personalized device of operation 2002 can include operation 2018, that can include, but is not limited to, obtaining the identifiable aspect of the supposed owner of a radio-frequency identification (RFID) card. For example, wherein the personalized device includes the radio-frequency identification (RFID) card, as described in this disclosure. One embodiment of the obtaining an identifiable aspect of a supposed owner of a personalized device of operation 2002 can include operation 2020, that can include, but is not limited to, obtaining an appearance of the supposed owner of the personalized device. For example, obtaining the appearance of the supposed owner such as by capturing an image of the supposed owner. One embodiment of the obtaining an identifiable aspect of a supposed owner of a personalized device of operation 2002 can include operation 2022, that can include, but is not limited to, obtaining a skin color or hair color of the supposed owner of the personalized device. For example, obtaining the skin color of the supposed owner such as by capturing an image of the supposed owner. One embodiment of the obtaining an identifiable aspect of a supposed owner of a personalized device of operation 2002 can include operation 2024, that can include, but is not limited to, obtaining a fingerprint of the supposed owner of the personalized device. For example, obtaining a fingerprint of the supposed owner such as by utilizing imaging, electronic fingerprinting, or other suitable technologies. One embodiment of the obtaining an identifiable aspect of a supposed owner of a personalized device of operation 2002 can include operation 2026, that can include, but is not limited to, obtaining a location of the supposed owner of the personalized device. For example, determining where the supposed owner of the personalized device is situated, such as by utilizing GPS, position-determining feedback, or other suitable positioning information. One embodiment of the obtaining an identifiable aspect of a supposed owner of a personalized device of operation 2002 can include operation 2028, that can include, but is not limited to, asking the supposed owner to obtain the identifiable aspect. For example, querying the supposed owner, or asking the supposed owner, you with response can be utilized to determine the identifiable aspect. One embodiment of the determining whether the supposed owner of the personalized device is a true owner of the personalized device based at least in part on the obtaining the identifiable aspect of the supposed owner of the personalized device of operation 2004 can include operation 2030, that can include but is not limited to providing a prescribed identification period to allow the true owner an opportunity to respond. For example, providing a prescribed identification period by which the personalized device can be returned to the true owner for identification purposes, such as if a credit card is temporarily in the position of a cashier, etc and could be quickly returned to the true owner. One embodiment of operation 2040 can include, but is not limited to, altering a status of the personalized device. For example, altering a status of the personalized device such as by switching from a license to a credit card, etc. One embodiment of operation 2042 can include, but is not limited to, altering an identification number of the personalized device. For example, altering the identification number associated with a personalized device, such as upon apparent theft of the personalized device. One embodiment of operation 2044 can include, but is not limited to, altering a PIN number of the personalized device. For example, altering the personalized identification number (PIN) of the personalized device. One embodiment of operation 2046 can include, but is not limited to, altering an owner of the personalized device. For example, altering the owner of the personalized device, such as by sale, transfer, etc. One embodiment of operation 2048 can include, but is not limited to, altering a status of the personalized device based at least in part on an indication that the personalized device is not possessed by the true owner. For example, altering the operational characteristics of the personalized device, such as by actuating the personalized device and/or alerting an authority, etc., upon the indication that the personalized device is not possessed by the true owner. One embodiment of operation 2050 can include, but is not limited to, initiating the true owner of the personalized device with respect to the personalized device. For example, initiating the personalized device owner identifier such as to indicate the true owner thereof. The order of the operations, methods, mechanisms, etc. as described with respect to FIG. 8 (including FIGS. 8a to 8c) is intended to be illustrative in nature, and not limited in scope.

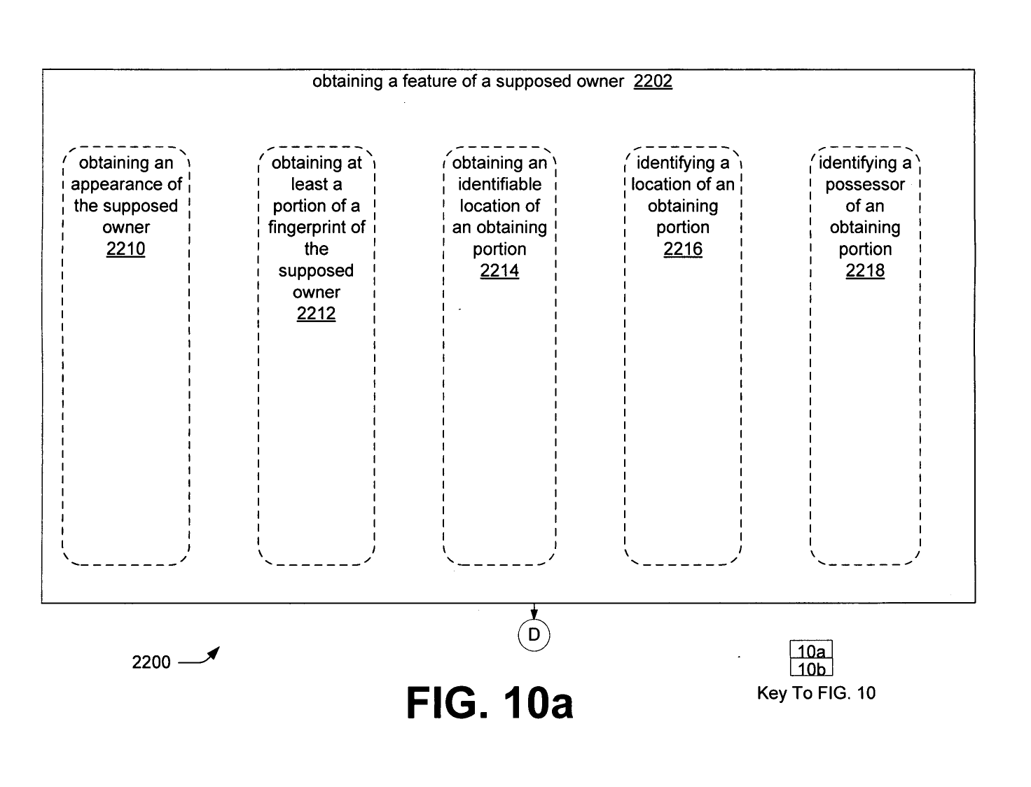

FIG. 9 shows one embodiment of the personalized device owner identifier 100, which can be configured to obtain a feature of the supposed owner of the personalized device 102 as described in this disclosure. Examples of obtaining the feature of the supposed owner which can be utilized as an identifying technique can include, but is not limited to, capturing images of identifiable aspects of the owner, retinal scans of the owner, voice prints of the owner, etc. as described in this disclosure. Certain embodiments of an identifying mechanism can thereupon be utilized to identify an aspect of a personalized device owner identifier based at least in part on the obtaining the feature of the supposed owner.

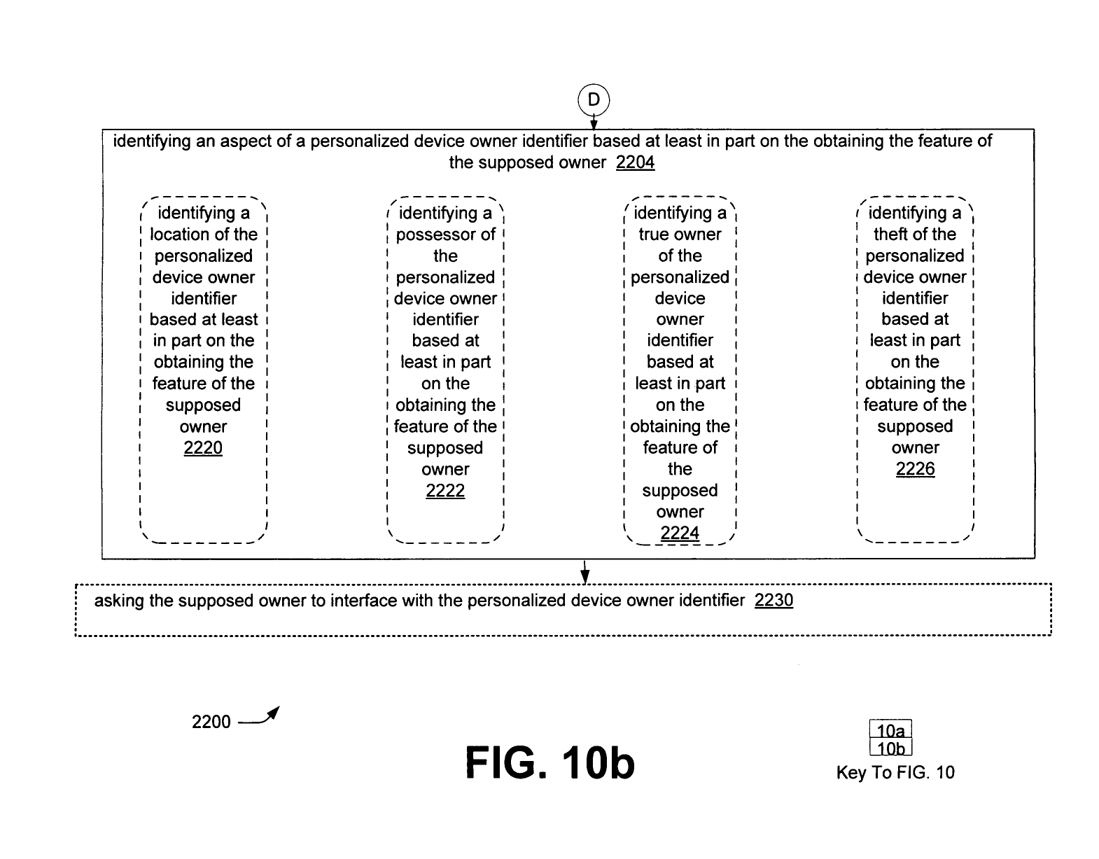

One embodiment of a high-level flowchart of a personalized device owner identifier technique 2200 is described with respect to FIG. 10 (including FIGS. 10a and 10b) and can include, but is not limited to, operations 2202 and 2204, and optional operation 2230. One embodiment of operation 2202 can include, but is not limited to, optional operations 2210, 2212, 2214, 2216, and/or 2218. One embodiment of operations 2204 can include, but is not limited to, optional operations 2220, 2222, 2224, and/or 2226. The high-level flowchart of FIG. 10 (including FIGS. 10a and 10b) should be considered in combination with the embodiments of the personalized device owner identifier 100, as described with respect to FIG. 9. One embodiment of operation 2202 can include, but is not limited to, obtaining a feature of a supposed owner. For example, capturing a picture or image, obtaining a retinal scan, obtaining a voiceprint, etc. of the supposed owner such as someone holding themselves out to be the owner. One embodiment of operation 2204 can include, but is not limited to, identifying an aspect of a personalized device owner identifier based at least in part on the obtaining the feature of the supposed owner. For example, identifying whether the supposed owner is the true owner at least in part on the obtaining the feature. In certain instances, for example, the aspect can be maintained as a portion of the personalized device owner identifier (either at the personalized device owner identifier or remotely). One embodiment of the obtaining a feature of a supposed owner of operation 2202 can include operation 2210, which can include, but is not limited to, obtaining an appearance of the supposed owner. For example, obtaining the appearance such as a facial expression or appearance, skin color, fingerprint, etc. of the supposed owner. One embodiment of the obtaining a feature of a supposed owner of operation 2202 can include operation 2212, which can include, but is not limited to, obtaining at least a portion of a fingerprint of the supposed owner. For example, obtaining at least the portion of the fingerprints utilizing, e.g., imaging or electronic fingerprinting technology. One embodiment of the obtaining a feature of a supposed owner of operation 2202 can include operation 2214, which can include, but is not limited to, obtaining an identifiable location of an obtaining portion. For example, determining whether the personalized device, or the person holding themselves out to be the owner thereof, is situated. In certain instances, the location can be determined either by imaging, photographic, or other positioning techniques such as GPS or other positioning technologies, etc. One embodiment of the obtaining a feature of a supposed owner of operation 2202 can include operation 2216, which can include, but is not limited to, identifying a location of an obtaining portion. For example, determining the location of the obtaining portion such as by utilizing GPS or other positioning technologies. One embodiment of the obtaining a feature of a supposed owner of operation 2202 can include operation 2218, which can include, but is not limited to, identifying a possessor of an obtaining portion. For example, identifying the possessor, of the personalized device who may be holding themselves out to be the true owner of the personalized device. One embodiment of the identifying an aspect of a personalized device owner identifier based at least in part on the obtaining the feature of the supposed owner of operation 2204 can include operation 2220, which can include, but is not limited to, identifying a location of the personalized device owner identifier based at least in part on the obtaining the feature of the supposed owner. For example, obtaining the feature of the supposed owner, such as by capturing an image thereof, and from there in determining the location such as by utilizing site information, or GPS or other positional information. One embodiment of the identifying an aspect of a personalized device owner identifier based at least in part on the obtaining the feature of the supposed owner of operation 2204 can include operation 2222, which can include, but is not limited to, identifying a possessor of the personalized device owner identifier based at least in part on the obtaining the feature of the supposed owner. For example, identifying the possessor of the personalized device owner identifier based at least in part on obtaining the feature, such as by capturing an image. One embodiment of the identifying an aspect of a personalized device owner identifier based at least in part on the obtaining the feature of the supposed owner of operation 2204 can include operation 2224, which can include, but is not limited to, identifying a true owner of the personalized device owner identifier based at least in part on the obtaining the feature of the supposed owner. For example, identifying the true owner of the personalized device owner identifier by obtaining the image, fingerprint, skin tone, etc. One embodiment of the identifying an aspect of a personalized device owner identifier based at least in part on the obtaining the feature of the supposed owner of operation 2204 can include operation 2226, which can include, but is not limited to, identifying a theft of the personalized device owner identifier based at least in part on the obtaining the feature of the supposed owner. For example, identifying the property, money, or identity theft, in certain instances, by determining whether the supposed owner is not the true owner of the personalized device. One embodiment of operation 2230 can include, but is not limited to, asking the supposed owner to interface with the personalized device owner identifier. For example, asking the supposed owner to interface with the personalized device owner identifier to ensure whether they are indeed the true owner. The order of the operations, methods, mechanisms, etc. as described with respect to FIG. 10 (including FIGS. 10a and 10b) is intended to be illustrative in nature, and not limited in scope.

In one or more various aspects, related systems include but are not limited to circuitry and/or programming for effecting the herein-referenced method aspects; the circuitry and/or programming can be virtually any combination of hardware, software, electro-mechanical system, and/or firmware configurable to effect the herein-referenced method aspects depending upon the design choices of the system designer.

### CONCLUSION

This disclosure provides a number of embodiments of the personalized device owner identifier 100. The embodiments of the personalized device owner identifier as described with respect to this disclosure are intended to be illustrative in nature, and not limiting its scope.

Those having skill in the art will recognize that the state of the art in computer, controller, communications, networking, and other similar technologies has progressed to the point where there is little distinction left between hardware, firmware, and/or software implementations of aspects of systems, such as may be utilized in the personalized device owner identifier. The use of hardware, firmware, and/or software can therefore generally represent (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle can vary with the context in which the processes and/or systems and/or other technologies are deployed. For example, if an implementer determines that speed and accuracy are paramount, the implementer and/or designer of the personalized device owner identifier may opt for mainly a hardware and/or firmware vehicle. In alternate embodiments, if flexibility is paramount, the implementer and/or designer may opt for mainly a software implementation. In yet other embodiments, the implementer and/or designer may opt for some combination of hardware, software, and/or firmware. Hence, there are several possible techniques by which the processes and/or devices and/or other technologies described herein may be effected, none of which is inherently superior to the other in that any vehicle to be utilized is a choice dependent upon the context in which the personalized device can be deployed and the specific concerns (e.g., speed, flexibility, or predictability) of the implementer, any of which may vary.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), Digital Signal Processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

It is to be understood by those skilled in the art that, in general, that the terms used in the disclosure, including the drawings and the appended claims (and especially as used in the bodies of the appended claims), are generally intended as “open” terms. For example, the term “including” should be interpreted as “including but not limited to”; the term “having” should be interpreted as “having at least”; and the term “includes” should be interpreted as “includes, but is not limited to”; etc. In this disclosure and the appended claims, the terms “a”, “the”, and “at least one” positioned prior to one or more goods, items, and/or services are intended to apply inclusively to either one or a plurality of those goods, items, and/or services.

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that could have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that could have A alone, B alone, C alone, A and B together, A and C together, B and C together, and/or A, B, and C together, etc.).

Those skilled in the art will appreciate that the herein-described specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A personalized device owner identifier, comprising:
an identification portion configurable to obtain an identifiable aspect of a supposed owner of a personalized device; and
the identification portion configurable to confirm the supposed owner of the personalized device as a true owner of the personalized device based at least in part on the identification portion configurable to obtain the identifiable aspect of the personalized device.

2. The personalized device owner identifier of claim 1, wherein the identification portion configurable to obtain an identifiable aspect of a supposed owner of a personalized device comprises:
the identification portion configurable to obtain the identifiable aspect of the supposed owner of a credit card.

3. The personalized device owner identifier of claim 1, wherein the identification portion configurable to obtain an identifiable aspect of a supposed owner of a personalized device comprises:
the identification portion configurable to obtain the identifiable aspect of the supposed owner of a smart card.

4. The personalized device owner identifier of claim 1, wherein the identification portion configurable to obtain an identifiable aspect of a supposed owner of a personalized device comprises:
the identification portion configurable to obtain the identifiable aspect of the supposed owner of an electronic key.

5. The personalized device owner identifier of claim 1, wherein the identification portion configurable to obtain an identifiable aspect of a supposed owner of a personalized device comprises:
the identification portion configurable to obtain the identifiable aspect of the supposed owner of a debit card.

6. The personalized device owner identifier of claim 1, wherein the identification portion configurable to obtain an identifiable aspect of a supposed owner of a personalized device comprises:
the identification portion configurable to obtain the identifiable aspect of the supposed owner of a personalized device personalized card.

7. The personalized device owner identifier of claim 1, wherein the identification portion configurable to obtain an identifiable aspect of a supposed owner of a personalized device comprises:
the identification portion configurable to obtain an appearance of a person of the supposed owner of the personalized device.

8. The personalized device owner identifier of claim 1, wherein the identification portion configurable to obtain an identifiable aspect of a supposed owner of a personalized device comprises:
the identification portion configurable to obtain a color of skin of the supposed owner of the personalized device.

9. The personalized device owner identifier of claim 1, wherein the identification portion configurable to obtain an identifiable aspect of a supposed owner of a personalized device comprises:
the identification portion configurable to obtain a fingerprint of the supposed owner of the personalized device.

10. The personalized device owner identifier of claim 1, wherein the identification portion configurable to obtain an identifiable aspect of a supposed owner of a personalized device comprises:
the identification portion configurable to obtain the identifiable aspect an identifiable location of the supposed owner of the personalized device.

11. The personalized device owner identifier of claim 1, wherein the identification portion configurable to obtain an identifiable aspect of a supposed owner of a personalized device comprises:
asking the supposed owner to obtain the identifiable aspect.

12. The personalized device owner identifier of claim 1, wherein the identification portion configurable to confirm the supposed owner of the personalized device as a true owner of the personalized device comprises:
the identification portion configurable to provide a prescribed identification period to allow the true owner an opportunity to identify themselves.

13. The personalized device owner identifier of claim 1, further comprising:
a status-change portion configurable to alter a status of the personalized device owner identifier.

14. The personalized device owner identifier of claim 1, further comprising:
a status-change portion configurable to alter an identification number of the personalized device owner identifier.

15. The personalized device owner identifier of claim 1, further comprising:
an initiating portion configurable to initiate the personalized device owner identifier.

16. The personalized device owner identifier of claim 1, further comprising:
a status-change portion configurable to alter a PIN number of the personalized device owner identifier.

17. The personalized device owner identifier of claim 1, further comprising:
a status-change portion configurable to alter an owner of the personalized device owner identifier.

18. The personalized device owner identifier of claim 1, further comprising:
a status-change portion configurable to alter a status of the personalized device owner identifier if the identification portion is unable to confirm the identifiable aspect of the supposed owner of the personalized device.

19. The personalized device owner identifier of claim 1, wherein the identification portion further comprises:
a status-change portion configurable to alter a status of the personalized device owner identifier based at least in part on an indication that the personalized device owner identifier is not possessed by the supposed owner.

20. A personalized device owner identifier comprising:
an obtaining portion configurable to obtain an aspect of a supposed owner; and
an identification portion configurable to identify the personalized device owner identifier based at least in part on the obtaining portion configurable to obtain the aspect of the supposed owner.

21. The personalized device owner identifier of claim 20, wherein the obtaining portion configurable to obtain an aspect of a supposed owner further comprises:
the obtaining portion configurable to obtain an appearance of the supposed owner.

22. The personalized device owner identifier of claim 20, wherein the obtaining portion configurable to obtain an aspect of a supposed owner further comprises:
the obtaining portion configurable to obtain at least a portion of a fingerprint of the supposed owner.

23. (canceled)

24. The personalized device owner identifier of claim 20, wherein the identification portion configurable to identify the personalized device owner identifier further comprises:
the identification portion configurable to identify a location of the obtaining portion.

25. The personalized device owner identifier of claim 20, wherein the identification portion configurable to identify the personalized device owner identifier further comprises:
the identification portion configurable to identify a possessor of the obtaining portion.

26. The personalized device owner identifier of claim 20, wherein the identification portion configurable to identify the personalized device owner identifier further comprises:
the identification portion configurable to identify a theft of the obtaining portion.

27. The personalized device owner identifier of claim 20, wherein at least one operation of the obtaining portion is based at least partially on a time.

28. The personalized device owner identifier of claim 20, wherein at least one operation of the obtaining portion is based at least partially on a change of a location.

29. (canceled)

30. The personalized device owner identifier of claim 20, further comprising:
the identification portion configurable to ask the supposed owner to interface with the personalized device owner identifier.

31. (canceled)

32. A method, comprising:
obtaining an identifiable aspect of a supposed owner of a personalized device; and
determining whether the supposed owner of the personalized device is a true owner of the personalized device based at least in part on the obtaining the identifiable aspect of the supposed owner of the personalized device.

33. (canceled)

34. (canceled)

35. (canceled)

36. (canceled)

37. (canceled)

38. The method of claim 32, wherein the obtaining an identifiable aspect of a supposed owner of a personalized device comprises:
obtaining an appearance of the supposed owner of the personalized device.

39. The method of claim 32, wherein the obtaining an identifiable aspect of a supposed owner of a personalized device comprises:
obtaining a skin color or hair color of the supposed owner of the personalized device.

40. The method of claim 32, wherein the obtaining an identifiable aspect of a supposed owner of a personalized device comprises:
obtaining a fingerprint of the supposed owner of the personalized device.

41. The method of claim 32, wherein the obtaining an identifiable aspect of a supposed owner of a personalized device comprises:
obtaining a location of the supposed owner of the personalized device.

42. The method of claim 32, wherein the obtaining an identifiable aspect of a supposed owner of a personalized device comprises:
asking the supposed owner to obtain the identifiable aspect.

43. The method of claim 32, wherein the determining whether the supposed owner of the personalized device is a true owner of the personalized device based at least in part on the obtaining the identifiable aspect of the supposed owner of the personalized device comprises:
providing a prescribed identification period to allow the true owner an opportunity to respond.

44. The method of claim 32, further comprising:
altering a status of the personalized device.

45. The method of claim 32, further comprising:
altering an identification number of the personalized device.

46. The method of claim 32, further comprising:
altering a PIN number of the personalized device.

47. The method of claim 32, further comprising:
altering an owner of the personalized device.

48. The method of claim 32, further comprising:
altering a status of the personalized device based at least in part on an indication that the personalized device is not possessed by the true owner.

49. The method of claim 32, further comprising:
initiating the true owner of the personalized device with respect to the personalized device.

50. A method comprising:
obtaining a feature of a supposed owner; and
identifying an aspect of a personalized device owner identifier based at least in part on the obtaining the feature of the supposed owner.

51. The method of claim 50, wherein the obtaining a feature of a supposed owner comprises:
obtaining an appearance of the supposed owner.

52. The method of claim 50, wherein the obtaining a feature of a supposed owner comprises:
obtaining at least a portion of a fingerprint of the supposed owner.

53. (canceled)

54. The method of claim 50, wherein the obtaining a feature of a supposed owner comprises:
identifying a location of an obtaining portion.

55. The method of claim 50, wherein the obtaining a feature of a supposed owner comprises:
identifying a possessor of an obtaining portion.

56. The method of claim 50, wherein the identifying an aspect of a personalized device owner identifier based at least in part on the obtaining the feature of the supposed owner comprises:
identifying a location of the personalized device owner identifier based at least in part on the obtaining the feature of the supposed owner.

57. The method of claim 50, wherein the identifying an aspect of a personalized device owner identifier based at least in part on the obtaining the feature of the supposed owner comprises:
identifying a possessor of the personalized device owner identifier based at least in part on the obtaining the feature of the supposed owner.

58. The method of claim 50, wherein the identifying an aspect of a personalized device owner identifier based at least in part on the obtaining the feature of the supposed owner comprises:
identifying a true owner of the personalized device owner identifier based at least in part on the obtaining the feature of the supposed owner.

59. The method of claim 50, wherein the identifying an aspect of a personalized device owner identifier based at least in part on the obtaining the feature of the supposed owner comprises:
identifying a theft of the personalized device owner identifier based at least in part on the obtaining the feature of the supposed owner.

60. The method of claim 50, further comprising:
asking the supposed owner to interface with the personalized device owner identifier.
